(19) United States
(12) Patent Application Publication
(10) Pub. No.: US 2022/0135412 A1
(43) Pub. Date: May 5, 2022

(54) LOW-TEMPERATURE FORMATION OF GROUP 13-15 CERAMICS AND GROUP 13-15-16 CERAMICS

(71) Applicant: University of Vermont and State Agricultural College, Burlington, VT (US)

(72) Inventors: Rory Waterman, Burlington, VT (US); Brandon Ackley, Burlington, VT (US)

(21) Appl. No.: 17/433,276

(22) PCT Filed: Feb. 11, 2020
(86) PCT No.: PCT/US20/17668

§ 371 Date: Aug. 24, 2021

Related U.S. Application Data
(60) Provisional application No. 62/817,278, filed on Mar. 12, 2019.

(51) Int. Cl. C01B 35/14; C01B 35/04; C01B 25/08

(52) U.S. Cl. CPC C01B 35/14; C01B 35/04; C01P 2004/03; C01P 2006/40; C01P 2002/88; C01B 25/087

(57) ABSTRACT

Methods of making a ceramic of a Group 13-15 type or a Group 13-15-16 type by thermolyzing a discrete molecular precursor to the ceramic in an oxygen-containing atmosphere. In some embodiments, the discrete molecular precursor is bench-stable and comprises a Lewis acid-base pair or small cyclic compound containing at last one Group 13 element and at least one Group 15 element but does not include indium and phosphorus in combination with one another unless a Group 16 element is present. The thermolysis can be carried out in air, at atmospheric pressure, and at a temperature below about 400° C., if desired. In some embodiments, the discrete molecular precursor can be placed in a mold having a desired shape and the thermolysis performed while the discrete molecular precursor is in the mold so as to produce a ceramic product having the desired shape.

### RELATED APPLICATION DATA

The application claims the benefit of priority of U.S. Provisional Patent Application Ser. No. 62/817,278, filed on Mar. 12, 2019, and titled “LOW-TEMPERATURE FORMATION OF GROUP 13-15 CERAMICS AND GROUP 13-15-16 CERAMICS”, which is incorporated herein by reference in its entirety.

### GOVERNMENT RIGHTS

This invention was made with government support under Grant CHE-1565658 awarded by the National Science Foundation and under Grant and Cooperative Agreement NNX15AP86H awarded by National Aeronautics and Space Foundation. The government has certain rights in the invention.

### FIELD OF THE INVENTION

The present invention generally relates to the field of ceramic formation. In particular, the present invention is directed to low-temperature formation of Group 13-15 ceramics and Group 13-15-16 ceramics.

### BACKGROUND

Semiconductors of Group 13-15 elements have seen widespread use in the electronics industry for decades, with uses ranging from light-emitting diodes to high energy lasers, among other semiconductor devices. While the industrial manufacturing of these materials allows for precise crystal growth, the creation of Group 13-15 semiconductors typically requires forcing formation conditions, commonly with temperatures exceeding 1,000° C. and/or at high pressures using high-pressure reactors. There have been efforts to form pre-ceramic materials starting with certain polymers with the hope that pre-forming some of the key bonds prior to thermolysis will result in lower thermolysis temperatures.

### SUMMARY

(1) A method of making a ceramic of a Group 13-15 type or a Group 13-15-16 type, the method comprising: providing a discrete molecular precursor of the ceramic, wherein the discrete molecular precursor is bench-stable and comprises a Lewis acid-base pair or small cyclic compound containing at least one Group 13 element and at least one Group 15 element but does not include indium and phosphorus in combination with one another unless a Group 16 element is present; and thermolyzing the discrete molecular precursor in an oxygen-containing atmosphere so as to form the ceramic.

(2) The method of (1), wherein the Lewis acid-base pair can be expressed as RₙH₃₋ₙE-E′R′_{n′}H_{3-n′}, wherein R is aryl or alkyl, E is a Group 13 element, E′ is a Group 15 element, R′ is aryl or alkyl, and each of n or n′ is either 3, 2, or 1.

(3) The method of (2), wherein the ceramic is of the Group 13-15-16 type, and E is bound to a Group 16 element.

(4) The method of (1), wherein the small cyclic compound can be expressed as (RₙH₂₋ₙE-E′R′_{n′}H_{2-n′})ₓ (x=2-5).

(5) The method of (1), wherein, if provided, the Group 16 element is introduced as an atomic species.

(6) The method of (1), wherein, if provided, the Group 16 element is introduced using a Group 16 delivery agent.

(7) The method of (6), wherein the Group 16 delivery agent comprises a peroxide.

(8) The method of (1), wherein thermolyzing the discrete molecular precursor in an oxygen-containing atmosphere includes thermolyzing the discrete molecular precursor in the oxygen-containing atmosphere at a temperature less than 400° C. or less for a time period less than 24 hours.

(9) The method of (8), wherein the temperature is less than 300° C.

(10) The method of (9), wherein the time period is less than 5 hours.

(11) The method of (1), wherein the ceramic is desired to have a molded shape, and the method further comprises placing the discrete molecular precursor into a mold having the molded shape prior to the thermolyzing.

(12) The method of (1), wherein the ceramic is a crystalline semiconductor.

(13) The method of (1), wherein the ceramic consists essentially of arsenic boride (AsB).

(14) The method of (13), wherein the discrete molecular precursor comprises a cyclo-arsineborane having the general formula (Ph₂AsBH₂)ₓ, wherein x=3, 4, 5.

(15) The method of (13), further comprising: reacting (C₆H₅)₂AsH with BH₃-THF to create the discrete molecular precursor; and thermolyzing the discrete molecular precursor so as to form the AsB.

(16) The method of (15), wherein thermolyzing the discrete molecular precursor includes thermolyzing the discrete molecular precursor at a temperature of less than 300° C. for a time period of less than 5 hours.

(17) The method of (1), wherein the ceramic consists essentially of phosphorous boride (PB).

(18) The method of (17), further comprising: reacting any one of P(C₆H₅)₃, P(C₆H₅)₂H, and P(C₆H₅)H₂ with BH₃-THF to create the discrete molecular precursor; and thermolyzing the discrete molecular precursor so as to form the PB.

(19) The method of (18), wherein thermolyzing the discrete molecular precursor includes thermolyzing the discrete molecular precursor at a temperature of less than 300° C. for a time period of less than 5 hours.

(20) The method of (1), wherein the ceramic consists essentially of gallium phosphide (GaP).

(21) The method of (20), further comprising: reacting (C₄H₉)₂GaCl with LiP(C₆H₅)₂ to create the discrete molecular precursor; and thermolyzing the discrete molecular precursor so as to form the GaP.

(22) The method of (21), wherein thermolyzing the discrete molecular precursor includes thermolyzing the discrete molecular precursor at a temperature of less than 300° C. for a time period of less than 5 hours.

(23) The method of (1), wherein the ceramic consists essentially of gallium arsenide (GaAs).

(24) The method of (23), further comprising: reacting (C₄H₉)₂GaCl with LiAs(C₆H₅)₂ to create the discrete molecular precursor; and thermolyzing the discrete molecular precursor so as to form the GaAs.

(25) The method of (24), wherein thermolyzing the discrete molecular precursor includes thermolyzing the discrete molecular precursor at a temperature of less than 300° C. for a time period of less than 5 hours.

(26) The method of (1), wherein the ceramic consists essentially of aluminum arsenide (AlAs).

(27) The method of (26), further comprising: reacting (C₄H₉)₂AlH with HAs(C₆H₅)₂ to create the discrete molecular precursor; and thermolyzing the discrete molecular precursor so as to form the AlAs.

(28) The method of (27), wherein thermolyzing the discrete molecular precursor includes thermolyzing the discrete molecular precursor at a temperature of less than 300° C. for a time period of less than 5 hours.

(29) The method of (1), wherein thermolyzing the discrete molecular precursor includes thermolyzing the discrete molecular precursor at atmospheric pressure.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIGS. 1A and 1B are, respectively, a thermograph of Compound 1 and a thermograph of Compound 1b; and

FIG. 2 is a mosaic of four images consisting of a photograph of Compound 2a (top left) (powdery; original colors: brownish amber to pale yellow), a photograph of Compound 2b (top right) (glassy; original color: primarily brownish amber), a scanning electron microscope (SEM) image of Compound 2a (bottom left), and an SEM image of Compound 2b (bottom right).

### DETAILED DESCRIPTION

In some aspects, the present disclosure is directed to methods of making ceramics of a Group 13-15 (formerly III-V) type or a Group 13-15-16 (formerly III-V-VI) type from bench-stable discrete molecular precursors using thermolysis in an oxygen-containing atmosphere (e.g., air) and at atmospheric pressure, as desired. Such formation methods can be desirable due to their ability to be performed at relatively low temperatures, in air, at ambient pressure, and with bench-stable precursors. In addition, many of the discrete molecular precursors suitable for methods disclosed herein can be readily prepared from simple commercial reagents. Moreover, some methods of the present disclosure can permit shaping of the formed ceramic into a desired shape by placing the corresponding discrete molecular precursor into a mold of the desired shape and thermolyzing the discrete molecular precursor while in the mold. For the sake of clarity, as used herein and in the appended claims the term “discrete molecular precursor” means a precursor in molecular form and not in a polymer form, and the term “bench-stable” means that the discrete molecular precursor so identified is resistant to oxidation and to moisture in an ambient air environment for handling, though some may have finite lifetimes if stored indefinitely in such an environment.

Extensive progress in pre-ceramic polymers has been achieved through the study of amine boranes. Some groups have probed both phosphine boranes and phosphine gallanes as pre-ceramic polymers, while others have investigated amine gallanes for use as precursors. Primary phosphine boranes have been utilized as precursors to high molecular weight pre-ceramic polymers, which formed boron phosphine (BP) in a low-temperature thermolysis. Researchers sought to utilize amine-stabilized GaH₃ precursors for chemical vapor deposition as gallium sources for GaE ceramics (E=Group 15 element) and observed changes in thermolysis properties based on the stabilizing amine. Other researchers observed that utilizing Ga₄N₈ caged structures lowered the thermolysis temperature to GaN to 700° C., demonstrating that pre-forming Group 13-15 bonds can lower the temperature of thermolysis. Still others were able to form GaAs and InP, respectively, from molecular precursors with thermolysis temperatures of 400° C. for 24 hours, demonstrating the effectiveness of this ceramic route.

Among the Group 13-15 ceramics, cubic boron arsenide (BAs) stands out with a high heat capacity of 1,000 WM⁻¹k⁻¹ and band gap of 1.5 eV. It has been theorized that impurities in the crystal lattice resulting from excess elemental arsenic limit the thermal properties of as-prepared cubic BAs, and the first synthesis of pure BAs has been reported only recently. An impurity in the thermolysis of BAs is boron subarsenide (Bi₂As₂), which is an interesting material in its own right, demonstrating the ability to self-heal radiation damage and possessing a bandgap of 3.47 eV, suggesting uses in solar applications. The formation of pure BAs requires forcing conditions with temperatures exceeding 1,000° C. and with reactions times around 35 days. Traditionally, Bi₂As₂ has been a byproduct of the thermolysis due to similar thermolysis temperatures and causes purification to be challenging, and the selective formation of one product is desirable. An additional source of impurities for BAs is the seed crystal used to promote controlled ceramic growth, which the use of pre-ceramic materials would avoid. The present inventors have postulated that long-chain polymers may not be needed to achieve productive, selective thermolysis in the case of secondary pnictogen borane precursors, because the main difference is one equivalent of H₂ per new E-E′ bond formed, which is not the primary loss in mass nor only loss in carbon.

Despite tremendous advances realized using pre-ceramic polymers, the present inventors have shown that discrete molecular precursors, rather than pre-ceramic polymers, appear to be optimal. A challenge the inventors faced was the increased bond energies of lighter Group 13-15 elements with organic substituents and the impact on thermolysis, ceramic yield, and purity.

Through hypotheses and experimentation, the present inventors have unexpectedly discovered that pure 13-15 ceramics and pure 13-15-16 ceramics can be formed by low-temperature thermolysis (e.g., less than about 400° C.) of certain bench-stable discrete molecular precursors in an oxygen containing atmosphere, including air, at atmospheric pressure, and for time periods generally less than about 24 hours, such as from about 2 hours to about 24 hours. For example, in some embodiments, the thermolysis temperature may be less than about 300° C., the time period of thermolysis may be less than 5 hours, or both the temperature may be less than about 300° C. and the time period may be less than about 5 hours. It is noted that throughout the present disclosure, the term “about” when used with a corresponding numeric value refers to ±20% of the numeric value, typically ±10% of the numeric value, often ±5% of the numeric value, and most often ±2% of the numeric value. In some embodiments, the term “about” means the numeric value itself.

It is noted that while formation can occur at temperatures below about 400° C., formation of 13-15 and 13-15-16 ceramics using techniques disclosed herein can tolerate temperatures of about 400° C. or higher. In addition, the techniques disclosed herein can tolerate thermolysis times longer than about 24 hours and/or pressures other than atmospheric pressures. However, higher temperature, longer thermolysis time, and/or non-atmospheric pressures will typically increase the amount of energy needed to form 13-15 and 13-15-16 ceramics using the techniques disclosed herein.

Discrete molecular precursors suitable for this technique include Lewis acid-base pairs of the class RₙH₃₋ₙE-E′R′_{n′}H_{3-n′}, wherein R is aryl or alkyl, E is a Group 13 element, E′ is a Group 15 element, R′ is aryl or alkyl, and each of n or n′ is either 3, 2, or 1. In these discrete molecular precursors, E′ may be bound to a Group 16 element. Indications are also that small rings (RₙH₂₋ₙE-E′R′_{n′}′H_{2-n′})ₓ (x=2-5) also behave similarly. The methodology is suggestive of one-to-one formulations, but the ratios of precursors can be varied. This may be more important for 13-15-16 ceramics.

Inclusion of Group 16 elements can occur at two times within the process as follows:
1. they may be introduced directly to the Group 15 element prior to the inclusion of the Group 13 element, as described above; and
2. they may be introduced to the Group 13-15 discrete molecular compound.
   Group 16 precursors can include an atomic species, for example, O₂, or can be provided through the use of a Group 16 delivery agent, such as a peroxide.

Experimentation—Boron Arsenide (BAs)

In experimentation by the present inventors, the borane-protected secondary arsine, Ph₂AsHBH₃, was sought as a potential precursor to BAs. In an effort to avoid decomposition, the reaction was carried out at −78° C. and under a hydrogen atmosphere to limit dehydrogenation. Treatment of Ph₂AsH with one equivalent of borane-tetrahydrofuran (THF) in a THF solution at −78° C. under an atmosphere of H₂ afforded a clear, colorless oil. This product was tentatively identified as Ph₂AsHBH₃ based on a ¹¹B nuclear magnetic resonance (NMR) resonance of δ=−35.2 (broad, J_{BH}=59 Hz). However, this liquid spontaneously decomposed at ambient temperature and was observed to visibly evolve gas at temperatures as low as −78° C. During this decomposition, several products formed as determined by ¹¹B NMR spectroscopy. The products were identified by ¹¹B NMR spectroscopy as (Ph₂AsBH₂)₃ (Compound 1) (broad, δ=−30.7), (Ph₂AsBH₂)_{4,5} (broad, δ=21-18), as well as borane-THF (δ=0.3) (eq. 1), with the identities of Compound 1 and (Ph₂AsBH₂)_{4,5} confirmed by mass spectrometry. Two additional unknown resonances were observed in the ¹¹B NMR spectrum during decomposition of Ph₂AsH—BH₃. A resonance at δ=−37.0 (broad) was suspected to be an unisolable intermediate in the decomposition, and the final resonance at δ=27.7 (doublet) that was not identified. The chemical shifts observed in ¹¹B NMR spectroscopy were similar to those observed with the analogous (Ph₂PBH₂)ₓ, which resonated at δ=−32.9 for x=3 and δ=−31.2 for x=4. Compound 1 was observed to disproportionate in solution to a mixture of (Ph₂AsBH₂)ₓ (x=3, 4, or 5). The mixture of (Ph₂AsBH₂)ₓ rings were analyzed as the crude mixture due to the innate disproportionation, and are discussed herein as Compound 1b. Spontaneous ring formation for heavier main Group elements is known, although the present inventors believe this is the first example of spontaneous ring formation involving an arsine borane.

In an effort to further investigate the ring formation, deuteration experiments were performed. The reaction of Ph₂AsD with BH₃-THF in toluene at −78° C. showed the formation of aryl C-D bonds (δ=7.15 ppm and δ=7.07 ppm) in the ²H NMR spectra. The surprising formation of the aryl deuterium bond suggests that activation of the phenyl groups off of arsenic was occurring, but it was unclear if the deuterium transfer occurs from the arsenic or the boron.

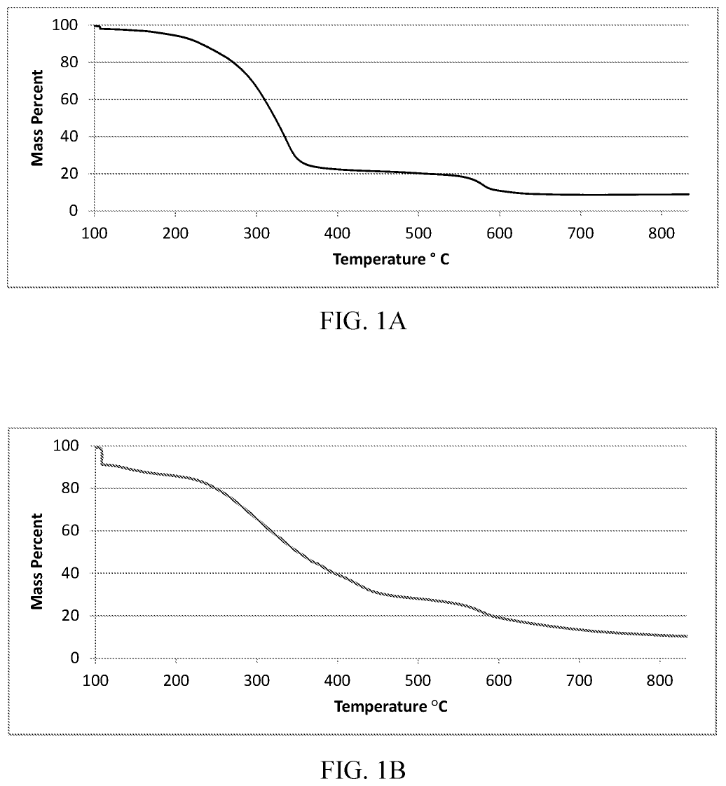

A concern when performing thermolysis on carbonaceous pre-ceramic polymers is the residual carbonaceous byproducts that limit material performance and are challenging to remove. In the thermogravimetric analysis (TGA) thermographs of Compounds 1 (FIG. 1A) and 1b (FIG. 1B), a mass loss equating to two equivalents of C₆H₆ was observed, corresponding to the equivalent of two phenyl rings. In FIG. 1A, the mass loss of Compound 1 occurs cleanly beginning at approximately 250° C. and ending around 360° C. In FIG. 1B, Compound 1b shows a much less uniform mass loss from the range of 275° C. to 450° C., which is attributed to the differing thermolysis temperatures of the different sized rings. At 590° C. in both thermographs, an additional mass loss event occurs. This mass loss is attributed to the beginning of the formation of Bi₂As₂.

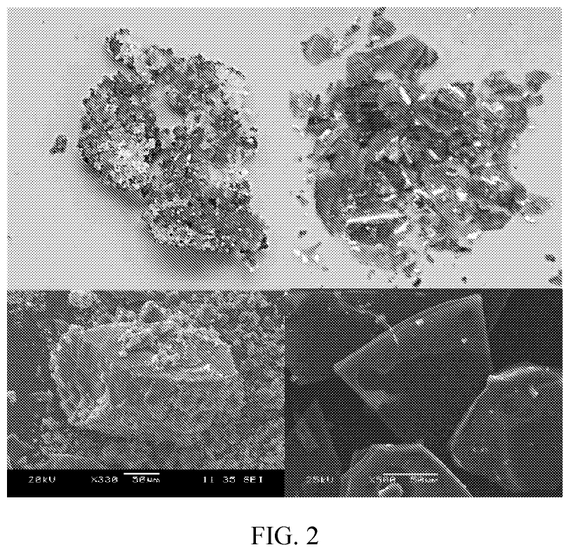

To address the concerns of carbonaceous byproducts, Compound 1 was thermolyzed at 300° C. in air, as well as under reduced pressure. When thermolyzed under reduced pressure, a mixture of products was obtained with a soft powdery texture (Compound 2a). When thermolyzed in air, one uniform product was obtained and observed as a brittle, glass-like solid (Compound 2b) (FIG. 2). The change in apparent morphology is attributed to the availability of molecular oxygen to oxidize the carbonaceous compounds facilitating loss of mass as CO₂. When thermolyzed under reduced pressure or under an inert atmosphere, the carbonaceous product has less impetus to leave the system as it cannot form a gaseous product. The powder X-ray diffraction (pXRD) pattern of Compound 2a matched the spectrum for cubic BAs; however, no powder pattern was observed for Compound 2b. During the thermolysis under reduced pressure, a second phase was identified in the reaction vessel. This phase was much darker in color, and the pXRD pattern matched Bi₂As₂. In the reduced pressure thermolysis, the ratio of the mass of all thermolysis products and the starting Compound 1 was found to be 37%, resulting in a ceramic yield of 37%. In the open-air thermolysis, the ceramic yield was found to be 16%.

The Lewis adduct Ph₂AsHBH₃ has been synthesized and has been demonstrated to thermally decompose into tetrameric and trimeric rings. The addition of catalytic chloro(1,5-cyclooctadiene)rhodium(I) dimer had no apparent effect on the system, in contrast to the related compound Ph₂PHBH₃. The thermolysis of these rings at 320° C. results in the formation of cubic BAs as well as Bi₂As₂ with a ceramic yield of 37%. These results demonstrated a promising step in the low temperature formation of ceramic boron arsenides, as well as suggested a method for exploring low temperature thermolysis of other main group ceramics.

### Examples

Based on the preceding experimentation, the present inventors prepared a number of 13-15 ceramics using discrete molecular precursors of a type described above. Following are five examples of 13-15 ceramics prepared in this manner. In each of these examples, thermolysis occurred in a preheated oven at temperatures ranging from 250° C. to 400° C. and for times ranging from 2 hours to 24 hours. All products were characterized using TGA, some were further characterized using band-gap analysis, scanning electron microscope, and/or pXRD. Those skilled in the art will readily understand that these examples are not limited but rather illustrative and that many other 13-15 ceramics and 13-15-16 ceramics can be made using techniques disclosed herein.

Arsenic Boride (AsB)

Similar to the experiment above, (C₆H₅)₂AsH was added to BH₃-THF, and the air-stable solid discrete molecular precursor product was thermolyzed for 2 hours in a pre-heated oven at 275° C. The product was characterized with TGA, pXRD, band-gap analysis, and scanning electron microscopy.

Phosphorous Boride (PB)

P(C₆H₅)₃, P(C₆H₅)₂H, and P(C₆H₅)H₂ were individually reacted with BH₃-THF in three separate experiments, and the air-stable discrete molecular precursor product in each was thermolyzed for 4 hours in a pre-heated oven at 275° C. The product was characterized with TGA and band-gap analysis.

Gallium Phosphide (GaP)

(C₄H₉)₂GaCl was reacted with LiP(C₆H₅)₂, and the air-stable discrete molecular precursor product was thermolyzed for 4 hours in a pre-heated oven at 275° C. The product was characterized with TGA and band-gap analysis.

Gallium Arsenide (GaAs)

(C₄H₉)₂GaCl was reacted with LiAs(C₆H₅)₂, and the air-stable discrete molecular precursor product was thermolyzed for 4 hours in a pre-heated oven at 275° C. The product was characterized with TGA and band-gap analysis.

Aluminum Arsenide (AlAs)

(C₄H₉)₂AlH was reacted with HAs(C₆H₅)₂, and the air-stable discrete molecular precursor product was thermolyzed for 4 hours in a pre-heated oven at 275° C. The product was characterized with TGA and band-gap analysis.

Example Uses and Moldability

Precursors can fill a mold prior to thermolysis to achieve a desired shape after thermolysis. A simple stainless steel mold is adequate for this purpose. Additionally, layers of precursor on a substrate, such as an ordered silicon surface, can be thermalized to deposit ceramic on the substrate surface.

A ceramic made using thermolysis techniques described herein can be formed, for example, on a semiconductor wafer (e.g., a silicon wafer) or other suitable substrate as a layer/material so as to become a functional part of one or more semiconductor devices and/or circuitry. Benefits of forming a ceramic layer/material in accordance with the disclosed thermolysis techniques flow directly from the conditions of the thermolysis, such as low temperature, standard atmospheric pressure (or slight vacuum or slight pressure), and an air (or other oxygen-containing) environment. As those skilled in the art will readily appreciate, the relatively low temperatures (e.g., less than about 400° C. or less than about 300° C., etc.) can be beneficial when another layer/material already present on the substrate would be damaged using a higher temperature. Another benefit of the relatively low-temperature thermolysis of the present disclosure is reduced energy usage. Regarding thermolysis pressure and environmental composition, the lack of need for complex and/or expensive processing equipment (e.g., high-vacuum equipment) and the lack of need for specialized and/or expensive gas(es) can result in lower production costs, including lower energy costs.

In some embodiments, a particular shape may be desired for a ceramic made using the techniques disclosed herein may be desirable. Since discrete molecular precursors used for these techniques are typically in liquid or powder form, they can be placed into a mold having the desired molded shape during thermolysis. At the completion of the thermolysis after the ceramic has formed, it will have a shape that matches the shape of the mold.

As an example in the context of semiconductor fabrication, a desired one, or combination, of the possible Group 13-15 or Group 13-15-16 ceramics of the present disclosure may be part of a particular circuitry design, and it may be desired as part of the fabrication process to form a layer of the ceramic(s) in a particular shape on the surface of a wafer. In this example, the method of forming such a shaped layer may generally include: providing the wafer; engaging a mold with the surface of the wafer; placing the precursor(s) to the desired ceramic(s) into the mold; thermolyzing the precursor(s) according to the present disclosure so as to form the desired ceramic layer; and removing the mold. As those skilled in the art will appreciate, the mold may be made of any suitable material, such as quartz, a ceramic, or other material capable of withstanding the thermolysis temperatures. The amount of precursor(s) placed into the mold will typically be predetermined based on the desired thickness of the formed ceramic layer. Following formation, the formed ceramic layer may be subjected to any one or more desired/necessary processing steps, such as planarizing, etching, annealing, implanting, etc., or any combination thereof, in the course of completing the semiconductor devices/circuitry of which the ceramic layer will be a part.

The foregoing has been a detailed description of illustrative embodiments of the invention. It is noted that in the present specification and claims appended hereto, conjunctive language such as is used in the phrases “at least one of X, Y and Z” and “one or more of X, Y, and Z,” unless specifically stated or indicated otherwise, shall be taken to mean that each item in the conjunctive list can be present in any number exclusive of every other item in the list or in any number in combination with any or all other item(s) in the conjunctive list, each of which may also be present in any number. Applying this general rule, the conjunctive phrases in the foregoing examples in which the conjunctive list consists of X, Y, and Z shall each encompass: one or more of X; one or more of Y; one or more of Z; one or more of X and one or more of Y; one or more of Y and one or more of Z; one or more of X and one or more of Z; and one or more of X, one or more of Y and one or more of Z.

Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve aspects of the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A method of making a ceramic of a Group 13-15 type or a Group 13-15-16 type, the method comprising:
providing a discrete molecular precursor of the ceramic, wherein the discrete molecular precursor is bench-stable and comprises a Lewis acid-base pair or small cyclic compound containing at least one Group 13 element and at least one Group 15 element but does not include indium and phosphorus in combination with one another unless a Group 16 element is present; and
thermolyzing the discrete molecular precursor in an oxygen-containing atmosphere so as to form the ceramic.

2. The method of claim 1, wherein the Lewis acid-base pair can be expressed as RₙH₃₋ₙE-E′R′_{n′}H_{3-n′}, wherein R is aryl or alkyl, E is a Group 13 element, E′ is a Group 15 element, R′ is aryl or alkyl, and each of n or n′ is either 3, 2, or 1.

3. The method of claim 2, wherein the ceramic is of the Group 13-15-16 type, and E′ is bound to a Group 16 element.

4. The method of claim 1, wherein the small cyclic compound can be expressed as (RₙH₂₋ₙE-E′R′_{n′}H_{2-n′})ₓ (x=2-5).

5. The method of claim 1, wherein, if provided, the Group 16 element is introduced as an atomic species.

6. The method of claim 1, wherein, if provided, the Group 16 element is introduced using a Group 16 delivery agent.

7. The method of claim 6, wherein the Group 16 delivery agent comprises a peroxide.

8. The method of claim 1, wherein thermolyzing the discrete molecular precursor in an oxygen-containing atmosphere includes thermolyzing the discrete molecular precursor in the oxygen-containing atmosphere at a temperature less than 400° C. or less for a time period less than 24 hours.

9. The method of claim 8, wherein the temperature is less than 300° C.

10. The method of claim 9, wherein the time period is less than 5 hours.

11. The method of claim 1, wherein the ceramic is desired to have a molded shape, and the method further comprises placing the discrete molecular precursor into a mold having the molded shape prior to the thermolyzing.

12. The method of claim 1, wherein the ceramic is a crystalline semiconductor.

13. The method of claim 1, wherein the ceramic consists essentially of arsenic boride (AsB).

14. The method of claim 13, wherein the discrete molecular precursor comprises a cyclo-arsineborane having the general formula (Ph₂AsBH₂)ₓ, wherein x=3, 4, 5.

15. The method of claim 13, further comprising:
reacting (C₆H₅)₂AsH with BH₃-THF to create the discrete molecular precursor; and
thermolyzing the discrete molecular precursor so as to form the AsB.

16. The method of claim 15, wherein thermolyzing the discrete molecular precursor includes thermolyzing the discrete molecular precursor at a temperature of less than 300° C. for a time period of less than 5 hours.

17. The method of claim 1, wherein the ceramic consists essentially of phosphorous boride (PB).

18. The method of claim 17, further comprising:
reacting any one of P(C₆H₅)₃, P(C₆H₅)₂H, and P(C₆H₅)H₂ with BH₃-THF to create the discrete molecular precursor; and
thermolyzing the discrete molecular precursor so as to form the PB.

19. The method of claim 18, wherein thermolyzing the discrete molecular precursor includes thermolyzing the discrete molecular precursor at a temperature of less than 300° C. for a time period of less than 5 hours.

20. The method of claim 1, wherein the ceramic consists essentially of gallium phosphide (GaP).

21. The method of claim 20, further comprising:
reacting (C₄H₉)₂GaCl with LiP(C₆H₅)₂ to create the discrete molecular precursor; and
thermolyzing the discrete molecular precursor so as to form the GaP.

22. The method of claim 21, wherein thermolyzing the discrete molecular precursor includes thermolyzing the discrete molecular precursor at a temperature of less than 300° C. for a time period of less than 5 hours.

23. The method of claim 1, wherein the ceramic consists essentially of gallium arsenide (GaAs).

24. The method of claim 23, further comprising:
reacting (C₄H₉)₂GaCl with LiAs(C₆H₅)₂ to create the discrete molecular precursor; and
thermolyzing the discrete molecular precursor so as to form the GaAs.

25. The method of claim 24, wherein thermolyzing the discrete molecular precursor includes thermolyzing the discrete molecular precursor at a temperature of less than 300° C. for a time period of less than 5 hours.

26. The method of claim 1, wherein the ceramic consists essentially of aluminum arsenide (AlAs).

27. The method of claim 26, further comprising:
reacting (C₄H₉)₂AlH with HAs(C₆H₅)₂ to create the discrete molecular precursor; and
thermolyzing the discrete molecular precursor so as to form the AlAs.

28. The method of claim 27, wherein thermolyzing the discrete molecular precursor includes thermolyzing the discrete molecular precursor at a temperature of less than 300° C. for a time period of less than 5 hours.

29. The method of claim 1, wherein thermolyzing the discrete molecular precursor includes thermolyzing the discrete molecular precursor at atmospheric pressure.
